(19) United States
(12) Patent Application Publication
(10) Pub. No.: US 2026/0194983 A1
(43) Pub. Date: Jul. 9, 2026

(54) Portable Haptic Device with Enhanced Navigation and Foldability Features

(71) Applicant: Haply Robotics Inc., Montreal (CA)

(72) Inventors: Felix Desourdy, Montreal (CA); Yi Ding, Montreal (CA); Colin Gallacher, Montreal (CA); Ramin Mersi, Montreal (CA); Romain Bursi, Montreal (CA); Antoine Weill-Duflos, Montreal (CA)

(21) Appl. No.: 19/441,340

(22) Filed: Jan. 6, 2026

Related U.S. Application Data
(60) Provisional application No. 63/742,142, filed on Jan. 6, 2025.

(51) Int. Cl. G06F 3/01; G06F 3/0354; G08B 6/00

(52) U.S. Cl. CPC G06F 3/016; G06F 3/03543; G08B 6/00

(57) ABSTRACT

A portable haptic device designed for enhanced navigation and foldability is disclosed herein. Key features include fold-flat arms, modular handles, internal capstans, and advanced power delivery systems. These elements enable intuitive user interaction, seamless 2D to 3D transitions, and robust adaptability for professional and consumer applications.

### CROSS-REFERENCE TO RELATED APPLICATIONS

This application claims the priority benefit of United States Provisional Patent Application Serial No. 63/742,142 for a Portable Haptic Device with Enhanced Navigation and Foldability Features, filed on 01/06/2025, which is hereby incorporated by reference in its entirety.

### BACKGROUND

The growing demand for haptic devices in fields such as virtual reality, medical training, and robotics necessitates portable solutions that integrate advanced functionality without compromising ergonomics. Current devices are often bulky, difficult to transport, or lack adaptability to various use cases.

### SUMMARY

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

A portable haptic device can include a base, a body, and a linkage assembly. The body can be mounted to the base for rotational movement relative to the base. The linkage assembly can be mounted to the body for rotational movement relative to the body.

### BRIEF DESCRIPTION OF THE DRAWINGS

FIG. 1A: a top view of an exemplary embodiment of a portable haptic device of the present disclosure.

FIG. 1B: a right side view of the exemplary embodiment shown in FIG. 1.

FIG. 2A: a first isometric view of the exemplary portable haptic device with folded arms.

FIG. 2B: a second isometric view of the exemplary portable haptic device with arms unfolded to a first orientation and a body of the exemplary portable haptic device rotated relative to a base of the exemplary portable haptic device.

FIG. 3A: a top view of the exemplary portable haptic device with the body rotated relative to the base as shown isometrically in FIG. 2B with the arms unfolded to a second orientation.

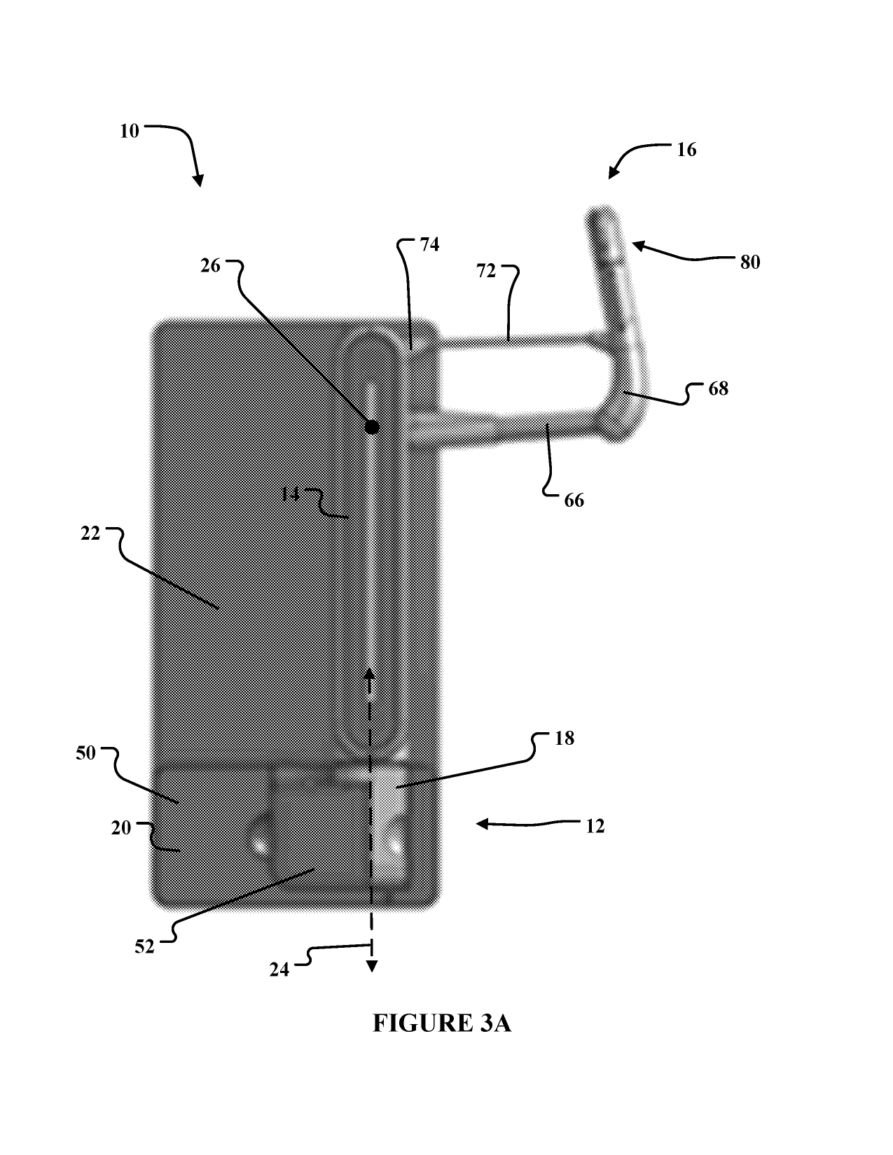

FIG. 3B: a top view of the exemplary portable haptic device with the body rotated relative to the base as shown isometrically in FIG. 2B with the arms unfolded to a third orientation.

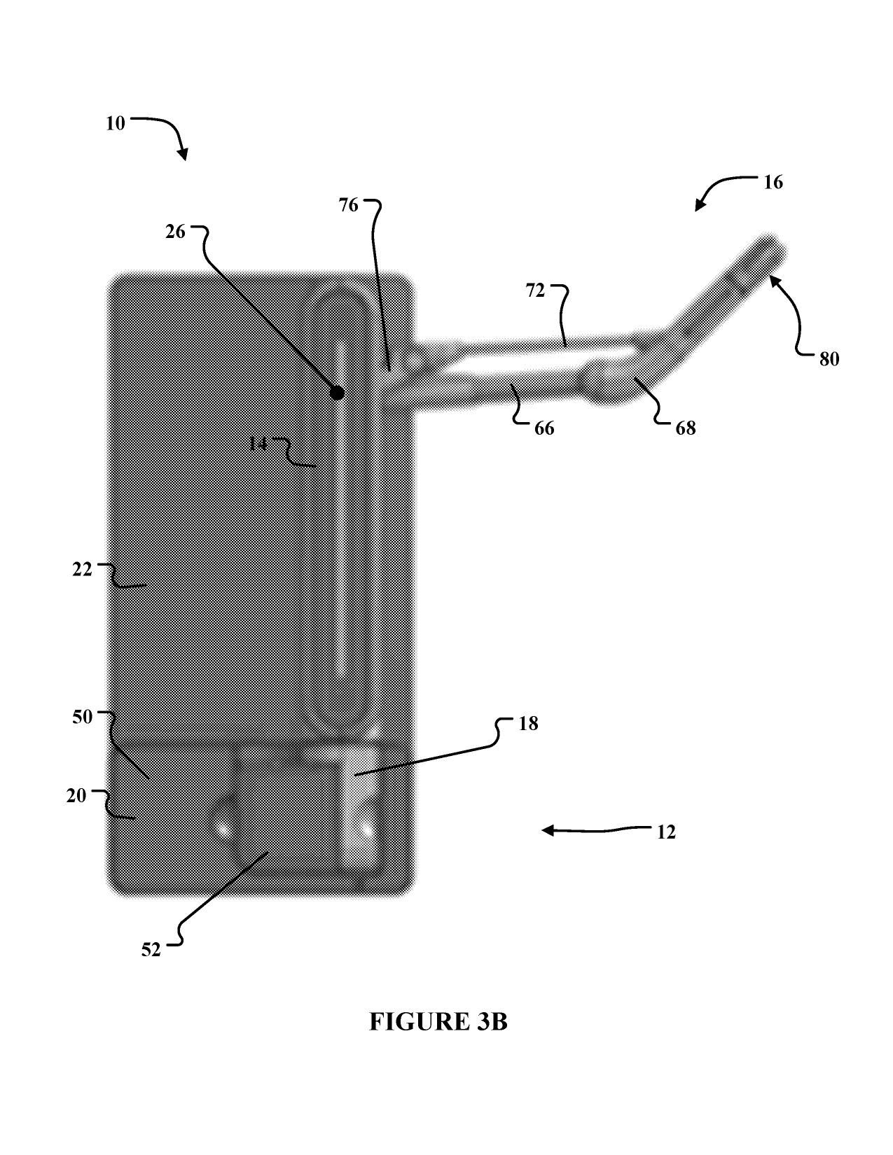

FIG. 3C: a top view of the exemplary portable haptic device with the body rotated relative to the base as shown isometrically in FIG. 2B with the arms unfolded to a fourth orientation.

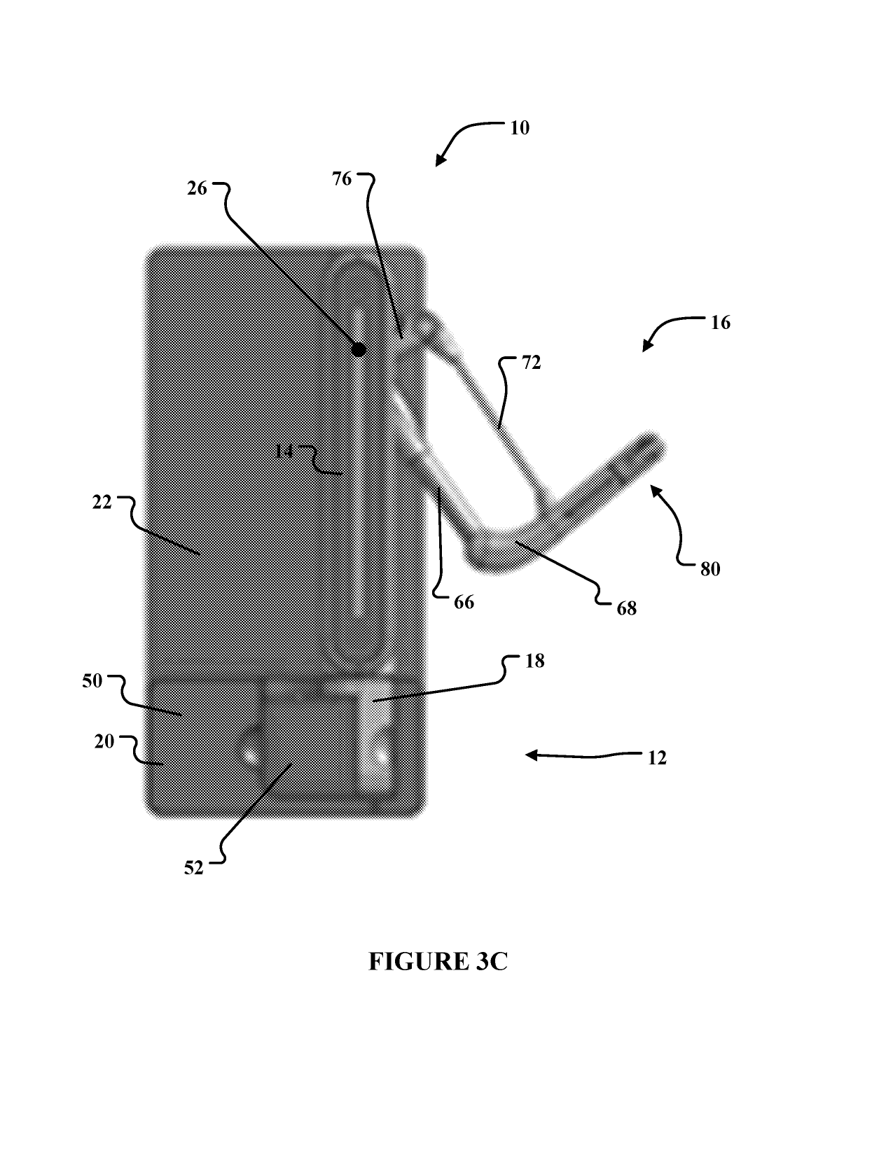

FIG. 3D: a top view of the exemplary portable haptic device with the body rotated relative to the base as shown isometrically in FIG. 2B with the arms unfolded to a fifth orientation.

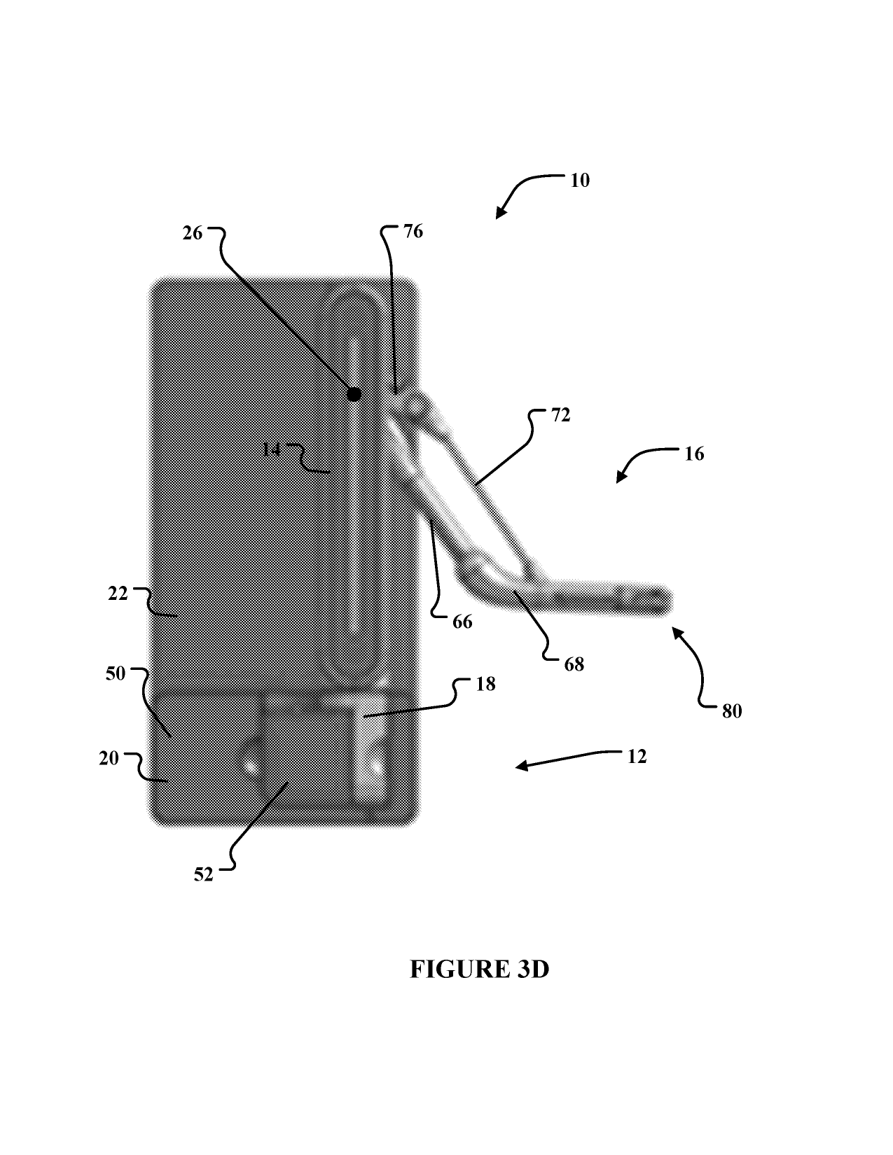

FIG. 3E: a top view of the exemplary portable haptic device with the body rotated relative to the base as shown isometrically in FIG. 2B with the arms unfolded to a third orientation.

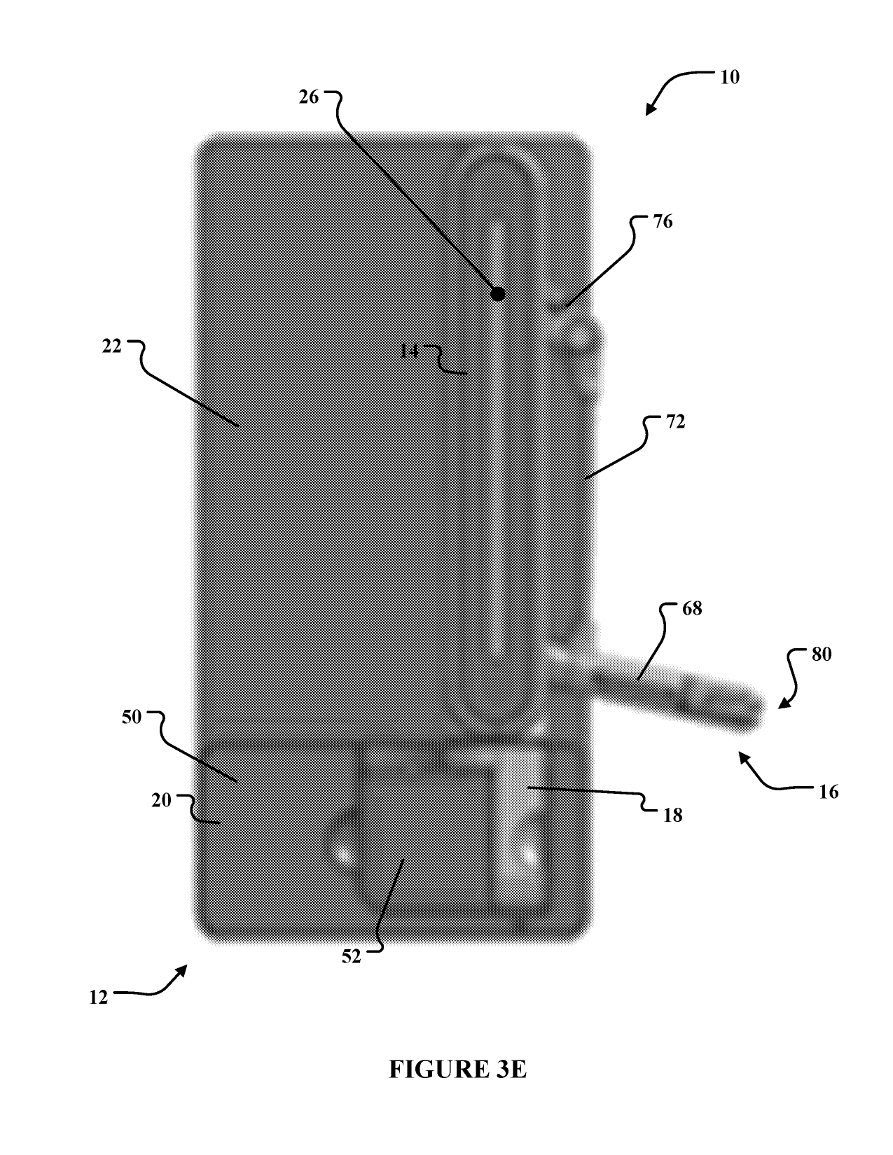

FIG. 4: a third isometric view of the exemplary portable haptic device with the body rotated relative to the base a different degree relative to the degree of relative rotation shown in FIG. 2B.

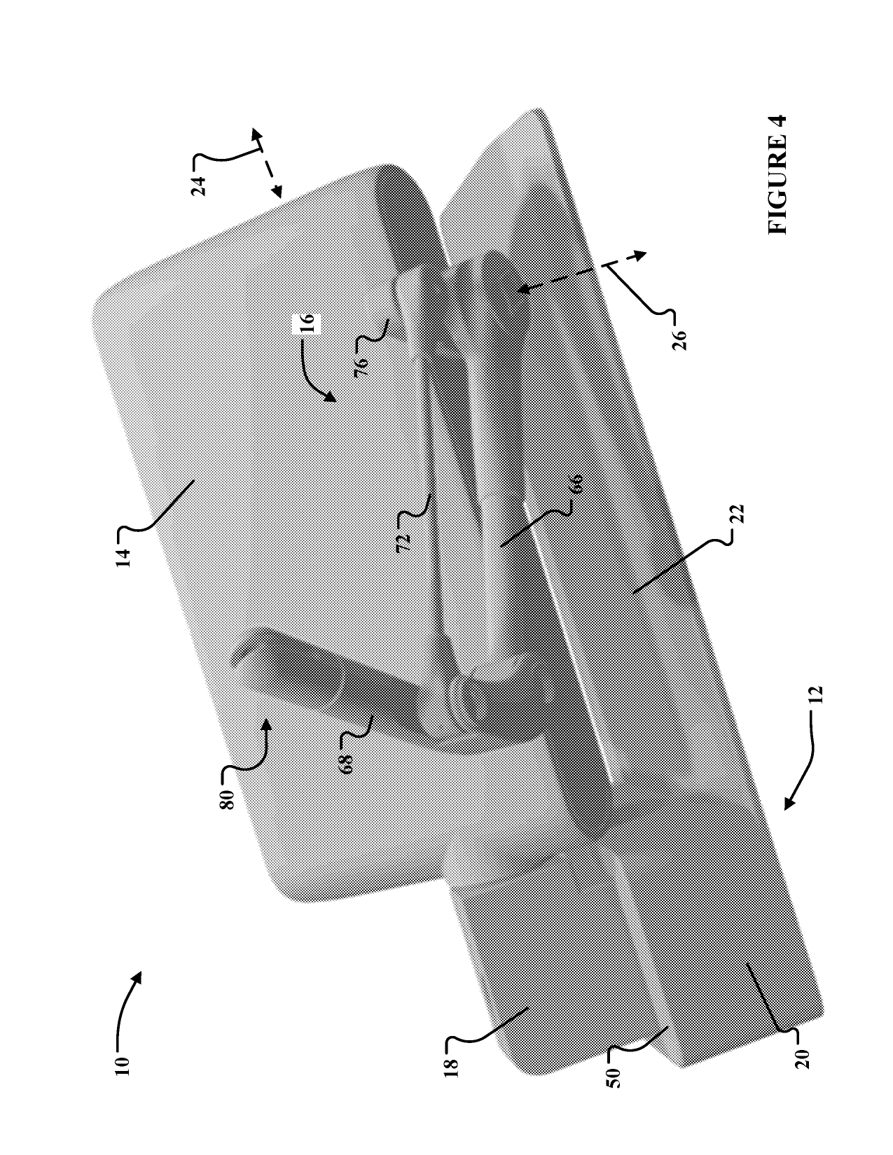

FIG. 5: a view of internal components of one or more of the exemplary portable haptic device.

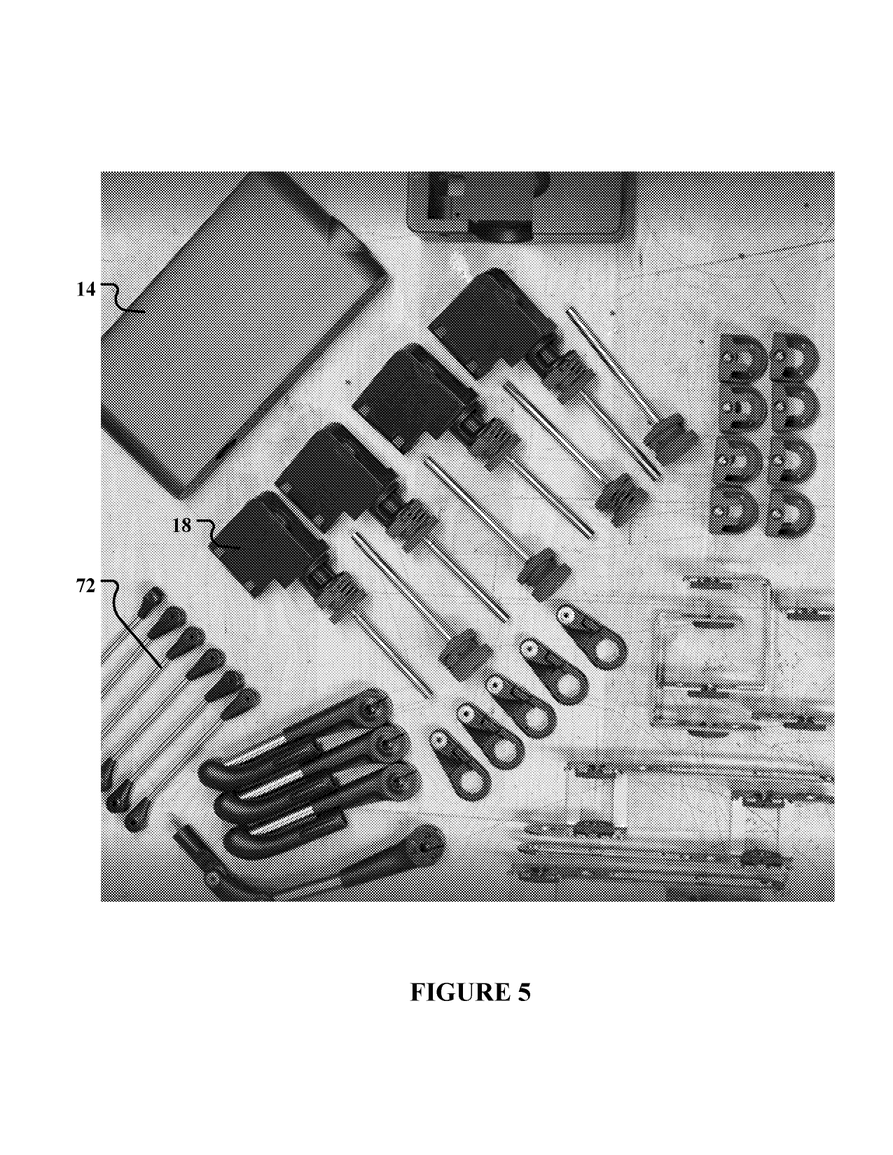

FIG. 6: a view of at least a portion of the exemplary portable haptic device being assembled.

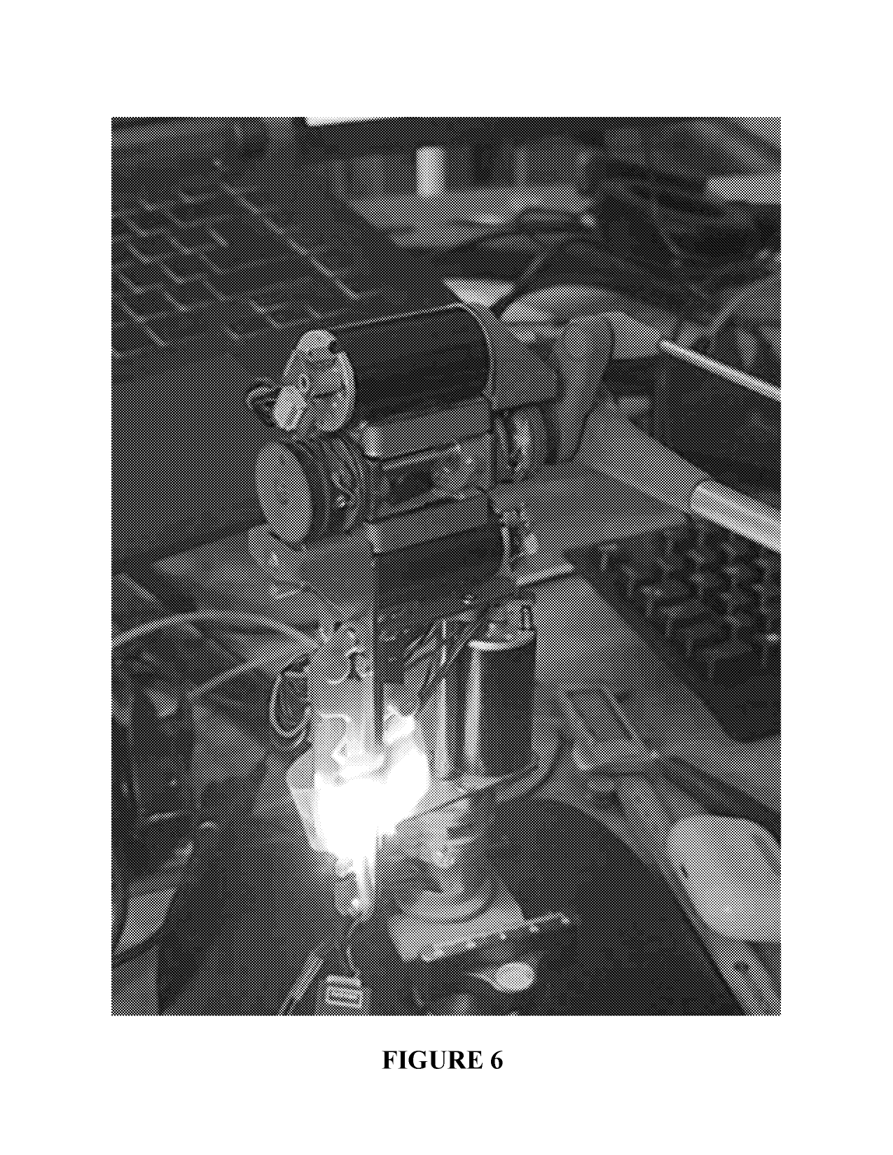

FIG. 7: a first isometric view of another exemplary portable haptic device according to the present disclosure being used as part of a two-dimensional (“2D”) mouse.

FIG. 8: a second isometric view of the exemplary portable haptic device shown in FIG. 7 being used as part of a three-dimensional (“3D”) mouse.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The subject matter of the present disclosure addresses these gaps by introducing a lightweight, compact, and modular haptic device that enhances user interaction and efficiency. Additionally, the subject matter of the present disclosure opens access to consumer products with even smaller designs, improved user experience (UX), lower costs, and increased robustness, making advanced haptic technology more accessible and practical for everyday use.

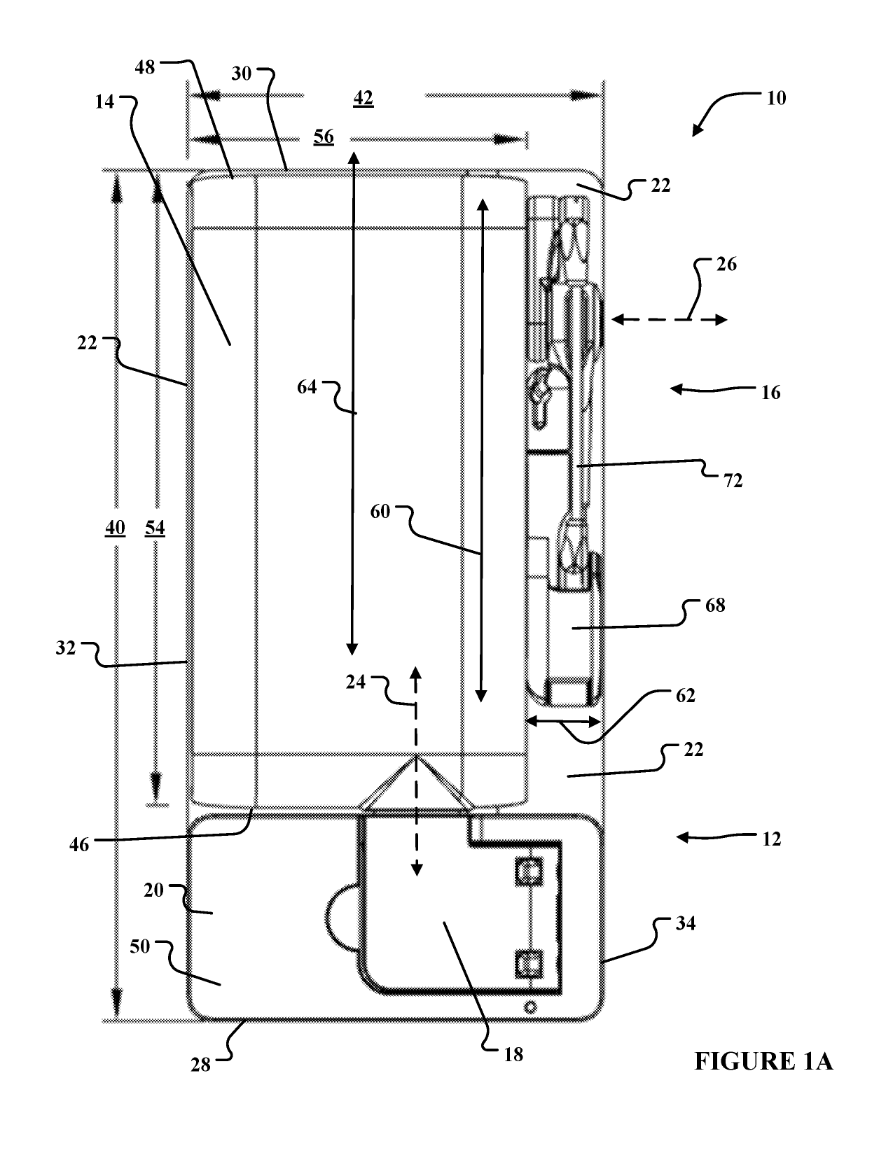

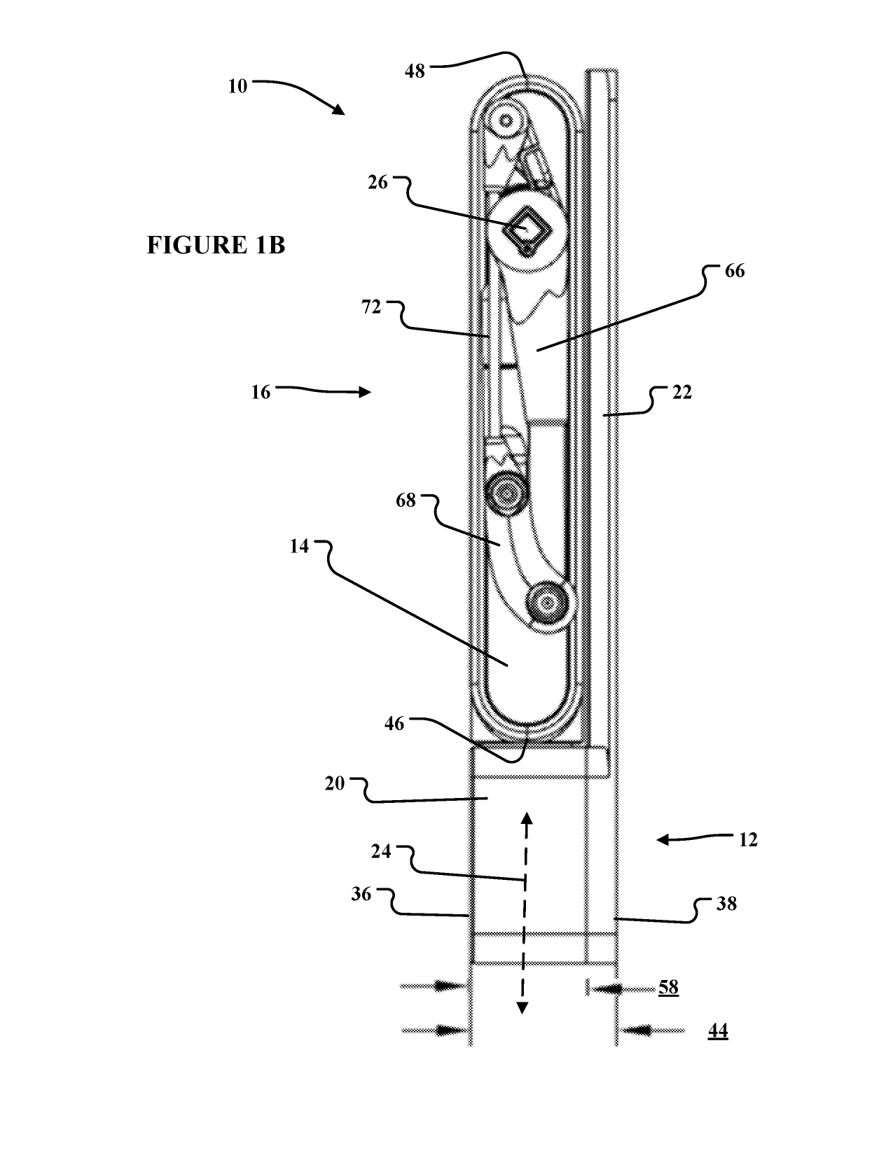

Referring now to FIGS. 1A – 4, an exemplary portable haptic device 10 includes a base 12, a body 14, and a linkage assembly 16. The exemplary body 14 is mounted to the exemplary base 12 for rotational movement relative to the exemplary base 12 about an axis 24 of rotation. The exemplary linkage assembly 16 is mounted to the exemplary body 14 for rotational movement relative to the exemplary body 14 about an axis 26 of rotation.

The exemplary base 12 includes an arm 18 that engages the exemplary body 14. The exemplary base 12 also includes a hub 20 to which the arm 18 is pivotally mounted. The exemplary base 12 includes a stabilizing plate 22 projecting away from the hub 20 underneath the exemplary body 14.

It is noted that the exemplary body 14 can house one or more sensors that can sense the relative rotational positions of the body 14 to the base 12 and of the linkage assembly 16 to the body 14. The exemplary body 14 can also house memory to hold programmed logic. The exemplary body 14 can also house one or more processors that can perform logic operations on the sensed data. The exemplary body 14 can also house one or more transceivers to receive and transmit data and/or commands. The exemplary body 14 can also house one or more motors or other force-generating devices to inhibit movement of the exemplary linkage assembly 22 and thus provide haptic feedback. The disclosure relating to “first portion 18” of pending application 18/025,207 is hereby incorporated in its entirety as applicable to the body 14.

Referring now to FIGS. 1A and 1B, the exemplary base 12 includes first, second, third, fourth, fifth and sixth sides 28 - 38 and defines a depth 40 of the exemplary base 12 extending between the first side 28 of the exemplary base 12 and the second side 30 of the exemplary base 12 and defines a width 42 of the exemplary base 12 extending between the third side 32 of the exemplary base 12 and the fourth side 34 of the exemplary base 12 and defines a height 44 of the exemplary base 12 between the fifth side 36 of the exemplary base 12 and the sixth side 38 of the exemplary base 12.

Referring again to FIGS. 1A and 1B, the exemplary body 14 engages the arm 18 at a first end 46 and extends to a distal, second end 48. The stabilizing plate 22 extends away from the hub 20 further than the exemplary body 14, beyond the second end 48.

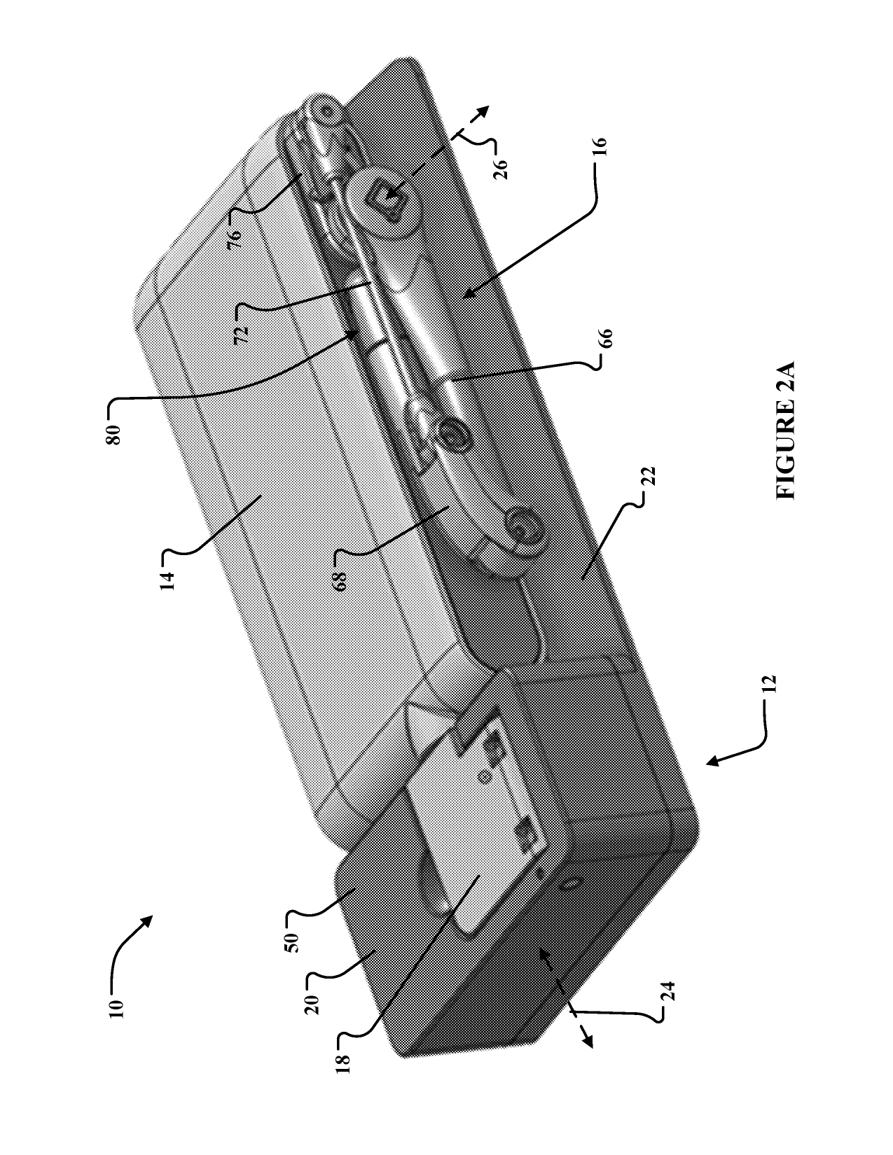

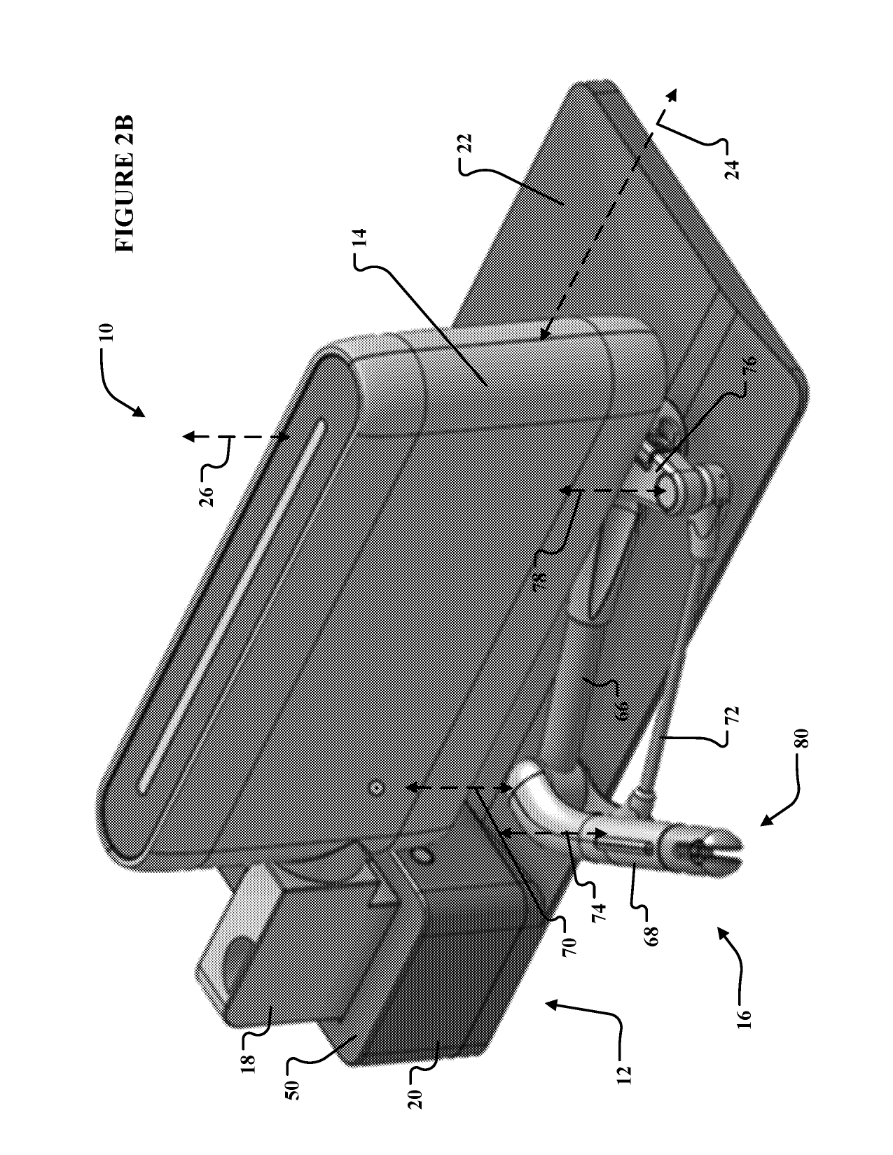

The axis 24 of rotation of the exemplary body 14 relative to the arm 18 is moved away from the stabilizing plate 22 when the arm 18 is pivoted from the first position to the second position. The axis 24 is further away from the stabilizing plate 22 in FIG. 2B than it is in FIG. 2A. Thus, the exemplary body 14 and the exemplary base 12 are interconnected such that the axis 24 of rotational movement of the exemplary body 14 is rectilinearly moveable relative to the exemplary base 12.

Referring again to FIGS. 1A and 1B, the exemplary body 14 includes first, second, third, fourth, fifth and sixth sides and defines a depth 54 extending between the first side (defined by first end 46) and the second side (defined by second end 48). The exemplary body 14 defines a width 56 extending between the third side and the fourth side. The exemplary body 14 defines a height 58 between the fifth side and the sixth side. The exemplary depth 54 is greater than the width 56 and greater than the height 58.

Referring again to FIGS. 1A and 1B, the exemplary linkage assembly 16 includes first, second, third, fourth, fifth and sixth sides and defines a depth 60 between its first side and second side. The exemplary linkage assembly 16 defines a width 62 between its third and fourth sides. The exemplary linkage assembly 16 defines a height which, in the exemplary embodiment, is substantially the same as the height 58 of the body.

As best shown in FIG. 1A, the exemplary axis 24 of rotational movement of the exemplary body 14 relative to the exemplary base 12 is offset from a first centerline axis 62 of the exemplary body 14. The exemplary first centerline axis 64 is centered on the width 56 of the exemplary body 14 and extends along the depth of the exemplary body 14.

The exemplary linkage assembly 16 includes a first link 66 engaged with the exemplary body 14 for rotation about the axis 26. The exemplary linkage assembly 16 also includes a second link 68 engaged with the first link 66 for rotation about a second axis 70 spaced from the axis 26. The exemplary linkage assembly 16 also includes a third link 72 engaged with the second link 68 for rotation about a third axis 74 spaced from axis 26 and the second axis 70. The exemplary linkage assembly 16 also includes a fourth link 76 engaged with the exemplary body 14 for rotation about the axis 26 and engaged with the third link 72 for rotation about a fourth axis 78 spaced from the axis 26.

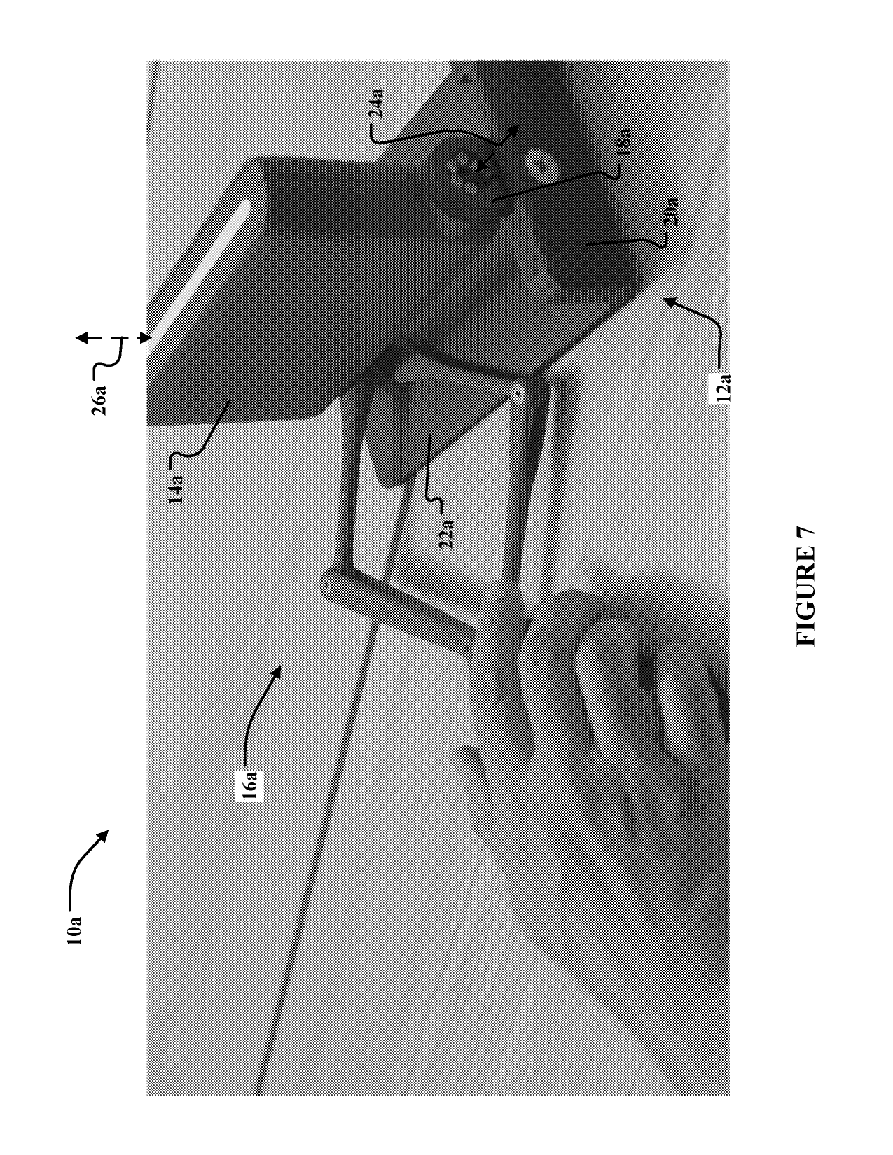

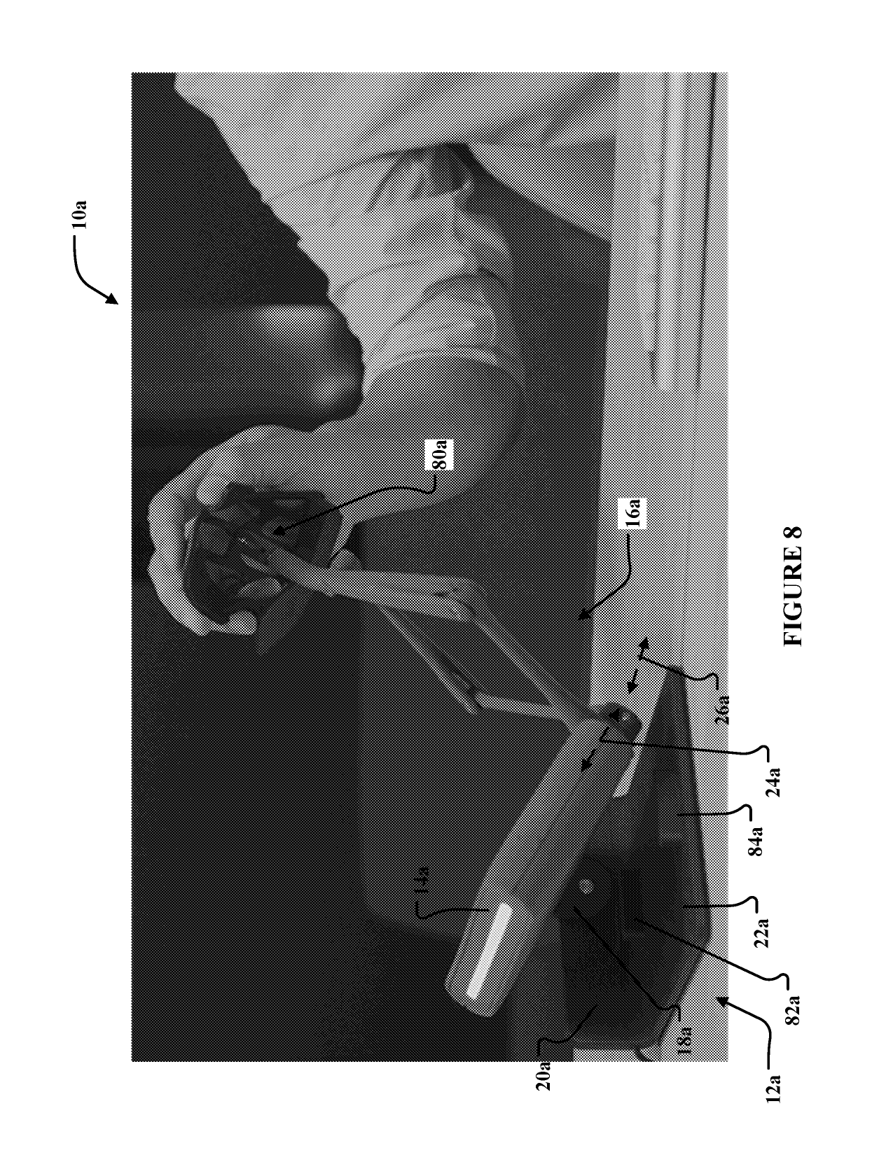

Referring now to FIGS. 7 and 8, an exemplary portable haptic device 10a includes a base 12a, a body 14a, and a linkage assembly 16a. The exemplary body 14a is mounted to the exemplary base 12a for rotational movement relative to the exemplary base 12a about an axis 24a of rotation. The exemplary linkage assembly 16a is mounted to the exemplary body 14a for rotational movement relative to the exemplary body 14a about an axis 26a of rotation.

The exemplary base 12a includes an arm 18a that engages the exemplary body 14a. The exemplary base 12a also includes a hub 20a to which the arm 18a is pivotally mounted. The exemplary base 12a includes a stabilizing plate 22a projecting away from the hub 20a underneath the exemplary body 14a.

The exemplary linkage assembly 16 also includes a quick-connect mechanism 80 (referenced at 80a in FIG. 8) mounted on the second link 68 to receive a multimodal tool, such as tool 202 of pending application 19/106,840 which is incorporated by reference. Any form of mechanical quick connector can be incorporated to an embodiment of the present disclosure, include push-to-connect/ball-and-sleeve (push to connect, retract sleeve to disconnect), a bayonet style in which twist-lock offers visual confirmation and compact design (e.g., pin-lock, claw), a cam-lock such as having foldable tabs for quick locking, common for hoses, or a Luer lock twisting connection.

The exemplary width 42 of the exemplary base 12 is greater than the exemplary width 56 of the exemplary body 14 and greater than the exemplary width 62 of the exemplary linkage assembly 16. The exemplary width 42 of the exemplary base 12 is greater than a combined value of the exemplary width 56 of the exemplary body 14 and greater than the exemplary width 62 of the exemplary linkage assembly 16. The exemplary depth 40of the exemplary base 12 is greater than the exemplary depth 54 of the exemplary body 14 and greater than the exemplary depth 62 of the exemplary linkage assembly 16.

In the exemplary embodiment, as best shown in FIGS. 2B and 7, when the exemplary body 14 is rotated relative to the exemplary base 12 to be transverse to the stabilizing plate 22, the exemplary linkage assembly 16 is positionable between the exemplary body 14 and the stabilizing plate 22 to contact the stabilizing plate 22. This provides support to the body 14. Further, the exemplary base 12 can also include at least one protuberance projecting away from the stabilizing toward the exemplary body 14 upon which the body 14 can rest. FIG. 8 shows two such protuberances 82a and 84a.

One or more embodiments can provide the following advantages:

Asymmetric Arm Mechanism for Portability: The asymmetric arm design uses shorter levers and avoids traditional hinge mechanisms, allowing for a compact and lightweight form. This configuration prevents the arms from colliding with external objects or other parts of the device during operation or folding. By carefully designing the asymmetric structure, the device achieves better stability when folded while maintaining precision during use. This approach enhances both portability and operational flexibility.

Foldable and Compact Device Form Factor: The device is designed to fold into a slim and compact profile, making it highly portable and easy to store. By reducing the overall volume by approximately 60% compared to earlier models, the device minimizes space requirements while maintaining all essential functionality. This foldability does not compromise structural integrity or performance, ensuring it is both durable and portable for frequent movement between locations.

Flat-Folding Base Mechanism: The flat-folding base contributes significantly to the device's portability by allowing the entire unit to lay flat during storage or transport. This design reduces the overall bulk of the system and enables easy packing into standard carrying cases or backpacks. The base remains sturdy and functional when unfolded, ensuring it supports the device securely without adding unnecessary weight or complexity.

Integrated PCB and Flex Ribbon Cable Configuration: By integrating all electronics, including the PCB and flex ribbon cables, within the device head, the design eliminates the need for external components or bulky wiring. This configuration not only reduces the device's overall footprint but also enhances reliability during transit by protecting sensitive electronics. The compact integration streamlines portability and simplifies the setup process for users moving between workspaces.

Portable Power Delivery via GAN Technology: The device incorporates GAN (Gallium Nitride) technology for efficient and lightweight power delivery, making it ideal for portable use. GAN technology reduces the size and weight of the power components while enabling rapid charging and power optimization. This feature ensures the device remains operational for extended periods, even in remote or mobile setups.

All Three Motors Contained Within the Head: Housing all three motors within the device head ensures a unified and compact structure, reducing the need for external or distributed components. This integration not only improves the device's portability but also enhances its performance by minimizing alignment and connection issues. The self-contained motor system makes the device easier to handle and transport, as there are fewer protruding or delicate parts.

Battery-Powered Operation: The inclusion of a built-in battery enables the device to function independently of external power sources, further enhancing portability. This feature makes the device suitable for various mobile applications, such as field demonstrations or temporary workstations. The battery-powered design ensures consistent performance without requiring a tethered setup, aligning with the ethos of portability and user convenience.

Detachable Handle and Arms: The handle and arms can be detached easily, breaking down the device into smaller components for more convenient transport. This modularity allows the user to pack and carry the device in compact spaces without compromising its structural integrity. The detachable design also simplifies maintenance and customization, enabling users to replace or upgrade individual parts without impacting the entire system.

Device Positioned on Its Side: The device can be positioned on its side to facilitate unique use cases, such as attaching a 2D mouse. This setup allows for seamless transformation from a standard 2D interaction to a 3D workspace by raising the mouse into the air. The side position also lowers the center of mass during use, improving stability and reducing applied force requirements, which enhances both portability and performance.

Internal Capstan System: The innovative capstan system uses a compact, conic-shaped design to enhance precision and reduce backlash during operation. By integrating a spring for auto-tension adjustment, the system ensures consistent cable tension, reducing wear and improving long-term reliability. The optimized capstan mechanism allows for smoother movements, enabling higher accuracy in haptic feedback and other precision tasks. This improvement is particularly critical for minimizing system instability, even under extended use or high-stress conditions.

Integrated Locking Mechanism: A flex-based locking mechanism ensures that device components remain securely in place during operation and transit. This design leverages the natural deflection of the device's materials to create a strong yet simple locking system. By eliminating the need for complex locking mechanisms, the design reduces potential failure points while maintaining a high level of stability. The mechanism's lightweight and cost-efficient nature align well with the device's overall goals of portability and performance.

Rotary Damper in Hinge: The rotary damper integrated into the hinge enhances stability and smoothness during folding and unfolding. Using a silicone oil-based damper, the hinge movement is controlled to avoid abrupt or uncontrolled motion, improving the user experience. This addition also reduces wear on the hinge and associated components by managing the forces applied during use. The damper’s cost- effectiveness ensures it adds value without significantly increasing the overall production cost.

Internal Rigid Frame: The internal rigid frame acts as the backbone of the device, providing strength and durability to support its components. This unibody frame design ensures precise alignment of motors, capstans, and other critical parts, reducing vibration and enhancing performance. By offering a stable foundation, the rigid frame also minimizes the risk of deformation or misalignment, even under heavy use. This structural integrity allows the device to perform consistently across a wide range of applications and environments.

Statically Balanced Around Side Rotating Hinge: The device's side-rotating hinge is designed to achieve static balance, making gravity compensation easier and improving stability during operation. This design reduces the need for additional compensatory forces, allowing for smoother and more efficient operation. By optimizing the center of gravity, the hinge ensures that movements remain precise and controlled, even in scenarios involving rapid directional changes. This balance also contributes to user comfort and reduces strain on the device's mechanical components.

Quick Connect Handle Interface: The handle’s quick connect mechanism allows users to attach and detach tooltips or handles rapidly, facilitating seamless transitions between tasks. This interface ensures a secure connection while maintaining a lightweight and efficient design. By enabling modularity, the quick connect interface supports various tool configurations, enhancing the device’s versatility. This feature also improves maintenance and upgradeability, allowing users to easily replace or enhance specific components as needed.

An exemplary embodiment of the present disclosure can define a portable haptic device featuring fold-flat arms with integrated rotary dampers for compact storage and stability.

An exemplary embodiment of the present disclosure can define a low-profile design with a low center of mass to ensure ergonomic stability during operation.

An exemplary embodiment of the present disclosure can include internal capstans fully enclosed to protect against environmental damage and ensure longevity.

An exemplary embodiment of the present disclosure can define a modular handle system with wireless connectivity and vibration feedback for enhanced user interaction.

An exemplary embodiment of the present disclosure can include an onboard navigation systems supporting large workspaces with bubble navigation techniques.

An exemplary embodiment of the present disclosure can include an advanced power delivery system leveraging GAN technology for efficient and lightweight operation.

An exemplary embodiment of the present disclosure can include a quick-connect mechanism allowing interchangeable bases and tooltips for versatile functionality.

An exemplary embodiment of the present disclosure can define an integration of design elements ensuring compatibility with both 2D and 3D interaction modes.

An exemplary embodiment of the present disclosure can define a customizable shell supporting different materials and colors for aesthetic and functional adaptability.

A method of intuitive user feedback through varying vibration frequencies to indicate navigation boundaries.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventors and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/-10%; in other instances there may be encompassed values in a range of approx. +/-5%; in yet other instances values in a range of approx. +/-2% may be encompassed; and in yet further instances, this may encompass values in a range of approx. +/-1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The expression “embodiment” herein does not relate to a specific set of features, but rather refers to preferred features described herein. The inventors also assert that any of the claims set forth after this detailed description can be combined with any other claim or claims regardless of whether or not there is a direct line of dependency, unless there is an express indication in this text or the drawings unambiguously indicating that such a combination is not possible. The order of the claims and the lines of dependency are irrelevant to the various ways that the features, elements, sub-elements, components, sub-components, etc. of the present disclosure can be combined and thus claimed. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings.

What is claimed is:

1. A portable haptic device comprising:
a base;
a body mounted to said base for rotational movement relative to said base; and
a linkage assembly mounted to said body for rotational movement relative to said body.

2. The portable haptic device of claim 1 wherein said base further comprises:
an arm that engages said body;
a hub to which said arm is pivotally mounted; and
a stabilizing plate projecting away from said hub underneath said body.

3. The portable haptic device of claim 2 wherein:
said body engages said arm at a first end and extends to a distal, second end; and
said stabilizing plate extends away from said hub further than said body, beyond said second end.

4. The portable haptic device of claim 2 wherein said arm is pivotally engaged with said hub, said arm is pivotal between a first position and a second position, when in said first position said arm is flush with an outer surface of said hub and received in a pocket defined in said hub, and when in said second position said arm is not flush with and projects away from said outer surface of said hub.

5. The portable haptic device of claim 4 wherein an axis of rotation of said body relative to said arm is moved away from said stabilizing plate when said arm is pivoted from said first position to said second position.

6. The portable haptic device of claim 1 wherein said body defines a depth extending between a first side and a second side and defines a width extending between a third side and a fourth side and defines a height between a fifth side and a sixth side, wherein depth is greater than said width and said height.

7. The portable haptic device of claim 6 wherein an axis of rotational movement of said body relative to said base is offset from a first centerline axis of said body, said first centerline axis centered on said width of said body and extends along said depth of said body.

8. The portable haptic device of claim 6 wherein said body and said base are interconnected such that said axis of rotational movement of said body is rectilinearly moveable relative to said base.

9. The portable haptic device of claim 1 wherein said linkage assembly further comprises:
a first link engaged with said body for rotation about a first axis;
a second link engaged with said first link for rotation about a second axis spaced from said first axis;
a third link engaged with said second link for rotation about a third axis spaced from first axis and said second axis; and
a fourth link engaged with said body for rotation about said first axis.

10. The portable haptic device of claim 9 wherein said linkage assembly further comprises:
a quick-connect mechanism mounted on said second link.

11. The portable haptic device of claim 1 wherein:
said body includes first, second, third, fourth, fifth and sixth sides and defines a depth extending between said first side and said second side and defines a width extending between said third side and said fourth side and defines a height between said fifth side and said sixth side;
said base includes first, second, third, fourth, fifth and sixth sides and defines a depth of said base extending between said first side of said base and said second side of said base and defines a width of said base extending between said third side of said base and said fourth side of said base and defines a height of said base between said fifth side of said base and said sixth side of said base;
said linkage assembly includes first, second, third, fourth, fifth and sixth sides and defines a depth of said linkage assembly extending between said first side of said linkage assembly and said second side of said linkage assembly and defines a width of said linkage assembly extending between said third side of said linkage assembly and said fourth side of said linkage assembly and defines a height of said linkage assembly between said fifth side of said linkage assembly and said sixth side of said linkage assembly; and
said width of said base is greater than said width of said body and greater than said width of said linkage assembly.

12. The portable haptic device of claim 11 wherein said width of said base is greater than a combined value of said width of said body and said width of said linkage assembly.

13. The portable haptic device of claim 11 wherein:
said body includes first, second, third, fourth, fifth and sixth sides and defines a depth extending between said first side and said second side and defines a width extending between said third side and said fourth side and defines a height between said fifth side and said sixth side;
said base includes first, second, third, fourth, fifth and sixth sides and defines a depth of said base extending between said first side of said base and said second side of said base and defines a width of said base extending between said third side of said base and said fourth side of said base and defines a height of said base between said fifth side of said base and said sixth side of said base;
said linkage assembly includes first, second, third, fourth, fifth and sixth sides and defines a depth of said linkage assembly extending between said first side of said linkage assembly and said second side of said linkage assembly and defines a width of said linkage assembly extending between said third side of said linkage assembly and said fourth side of said linkage assembly and defines a height of said linkage assembly between said fifth side of said linkage assembly and said sixth side of said linkage assembly; and
said depth of said base is greater than said depth of said body and greater than said depth of said linkage assembly.

14. The portable haptic device of claim 1 wherein
said base further comprises an arm that engages said body and a hub to which said arm is pivotally mounted and a stabilizing plate projecting away from said hub underneath said body;
said arm is pivotally engaged with said hub, said arm is pivotal between a first position and a second position, when in said first position said arm is flush with an outer surface of said hub and received in a pocket defined in said hub, and when in said second position said arm is not flush with and projects away from said outer surface of said hub;
an axis of rotation of said body relative to said arm is moved away from said stabilizing plate when said arm is pivoted from said first position to said second position; and
when said body is rotated relative to said base and is transverse to said stabilizing plate said linkage assembly is positionable between said body and said stabilizing plate to contact said stabilizing plate.

15. The portable haptic device of claim 1 wherein said base further comprises:
an arm that engages said body;
a hub to which said arm is pivotally mounted;
a stabilizing plate projecting away from said hub underneath said body; and
at least one protuberance projecting away from said stabilizing toward said body.
